(19) United States
(12) Patent Application Publication
(10) Pub. No.: US 2020/0231518 A1
(43) Pub. Date: Jul. 23, 2020

(54) PROCESSING CHEMICALS

(71) Applicant: XYLECO, INC., Wakefield, MA (US)

(72) Inventor: Marshall Medoff, Brookline, MA (US)

(21) Appl. No.: 16/548,967

(22) Filed: Aug. 23, 2019

Related U.S. Application Data
(63) Continuation of application No. 13/681,681, filed on Nov. 20, 2012, now abandoned.
Application No. 13/681,681 is a continuation of application No. PCT/US2011/037391, filed on May 20, 2011.
(60) Provisional application No. 61/347,705, filed on May 24, 2010.

(51) Int. Cl. C07B 61/00; B01J 19/08; C08J 3/28

(52) U.S. Cl. CPC C07B 61/00; C08J 3/28; B01J 19/085; B01J 19/08

(57) ABSTRACT

Methods of processing chemicals change their structure, and in particular increase their solubility and/or rate of dissolution, for intermediates and products made from the structurally changed materials. Many of the methods provide materials that can be more readily utilized in reactions or other processes to produce useful intermediates and products, e.g., energy, fuels, foods or materials. Chemicals that are treated using the processes described herein can be used to form highly concentrated solutions. Treatment can change the functionality of the chemical, and thus the polarity of the chemical, which may render the treated chemical soluble in solvents in which the untreated chemical is insoluble or only sparingly or partially soluble. Methods may in some cases increase the solubility of the chemical in water or aqueous media. The chemical may be, for example, a solid, liquid, or gel, or mixtures thereof.

### RELATED APPLICATIONS

This application is a continuation of U.S. application Ser. No. 13/681,681, filed Nov. 20, 2012, which is a continuation of International Application No. PCT/US2011/037391, which designated the United States and was filed on May 20, 2011, published in English, which claims the benefit of U.S. Provisional Application Ser. No. 61/347,705, filed on May 24, 2010. The entire disclosures of the above applications are incorporated herein by reference.

### BACKGROUND

Chemicals are used in a wide variety of reactions and processes, often to produce other intermediates and products. The solubility and/or rate of dissolution of a chemical in a solvent can affect the rate and/or efficiency of a process or chemical reaction in which the chemical is used. Thus, it would be desirable to control, e.g., increase, the solubility and/or rate of dissolution of chemicals.

### SUMMARY

Generally, this invention relates to methods of processing chemicals to change their structure, and in particular to increase their solubility and/or rate of dissolution, and intermediates and products made from the structurally changed materials. Many of the methods provide materials that can be more readily utilized in reactions or other processes to produce useful intermediates and products, e.g., energy, fuels, foods or materials.

In some implementations, chemicals that are treated using the processes described herein can be used to form highly concentrated solutions, e.g., solutions having a concentration higher than that of a saturated solution of the untreated chemical in the same solvent under the same conditions. In some cases, treatment changes the functionality of the chemical, and thus the polarity of the chemical, which may, for example, render the treated chemical soluble in solvents in which the untreated chemical is insoluble or only sparingly or partially soluble. For example, the methods may in some cases increase the solubility of the chemical in water or aqueous media. The chemical may be, for example, a solid, liquid, or gel, or mixtures thereof.

In one aspect, the invention features a method of increasing the solubility of a chemical comprising treating the chemical with a physical treatment selected from the group consisting of mechanical treatment, chemical treatment, radiation, sonication, oxidation, pyrolysis and steam explosion to increase the solubility of the chemical relative to the solubility of the chemical prior to physical treatment.

Some implementations include one or more of the following features. The chemical may be selected from the group consisting of salts, polymers, and monomers. The physical treatment may be or include irradiation, e.g., with an electron beam. In some cases, the physical treatment changes the functionality of the chemical. In implementations in which the chemical is irradiated, irradiating may comprise applying to the chemical a total dose of radiation of at least 5 Mrads.

The physically treated chemical may have a crystallinity that is at least 10 percent lower than the crystallinity of the chemical prior to physical treatment. In some cases, the chemical had a crystallinity index prior to physical treatment of from about 40 to about 87.5 percent, and the physically treated chemical has a crystallinity index of from about 10 to about 50 percent.

In another aspect, the method features a product comprising a chemical that has been treated with a physical treatment selected from the group consisting of mechanical treatment, chemical treatment, radiation, sonication, oxidation, pyrolysis and steam explosion, the product having a solubility that is higher than the solubility of the chemical prior to physical treatment.

Some implementations include one or more of the following features. The chemical may be selected from the group consisting of salts, polymers and monomers. In some cases, the chemical has been irradiated, e.g., with an electron beam. The product may have a functionality that is different from that of the chemical prior to physical treatment. In implementations in which the chemical is irradiated, the chemical may have been irradiated with a total dose of radiation of at least 30 Mrads. The physically treated chemical may have a crystallinity that is at least 10 percent lower than the crystallinity of the chemical prior to physical treatment. In some cases, the chemical had a crystallinity index prior to physical treatment of from about 40 to about 87.5 percent, and the physically treated chemical has a crystallinity index of from about 10 to about 50 percent.

The increase in solubility and/or rate of dissolution may result from a structural modification of the material. “Structurally modifying” a chemical, as that phrase is used herein, means changing the molecular structure of the chemical in any way, including the chemical bonding arrangement, crystalline structure, or conformation of the chemical. The change may be, for example, a change in the integrity of the crystalline structure, e.g., by microfracturing within the structure, which may not be reflected by diffractive measurements of the crystallinity of the material. Such changes in the structural integrity of the chemical can be measured indirectly by measuring the yield of a product at different levels of structure-modifying treatment. In addition, or alternatively, the change in the molecular structure can include changing the supramolecular structure of the chemical, oxidation of the chemical, changing an average molecular weight, changing an average crystallinity, changing a surface area, changing a degree of polymerization, changing a porosity, changing a degree of branching, grafting on other materials, changing a crystalline domain size, or changing an overall domain size. The structural modification may in some cases increase the polarity of the chemical, increase the ability of the chemical to form hydrogen bonds with water, and/or break the chemical into smaller molecules.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a block diagram illustrating conversion of a chemical into products and co-products.

### DETAILED DESCRIPTION

Using the methods described herein, chemicals (e.g., salts, polymers, monomers, pharmaceuticals, nutriceuticals, vitamins, minerals, neutral molecules, and mixtures thereof) can be processed to increase their solubility and/or rate of dissolution. In some cases, the processed chemical is in itself a finished product, while in other cases the processed chemical can be used to produce useful intermediates and products. Chemicals can be treated or processed using one or more of any of the methods described herein, such as mechanical treatment, chemical treatment, radiation, sonication, oxidation, pyrolysis or steam explosion. The various treatment systems and methods can be used in combinations of two, three, or even four or more of these technologies or others described herein and elsewhere.

These treatments will increase the solubility of the treated chemical in a solvent, which may be, for example, water, a non-aqueous solvent, e.g., an organic solvent, or mixtures thereof.

### Systems for Treating Chemicals

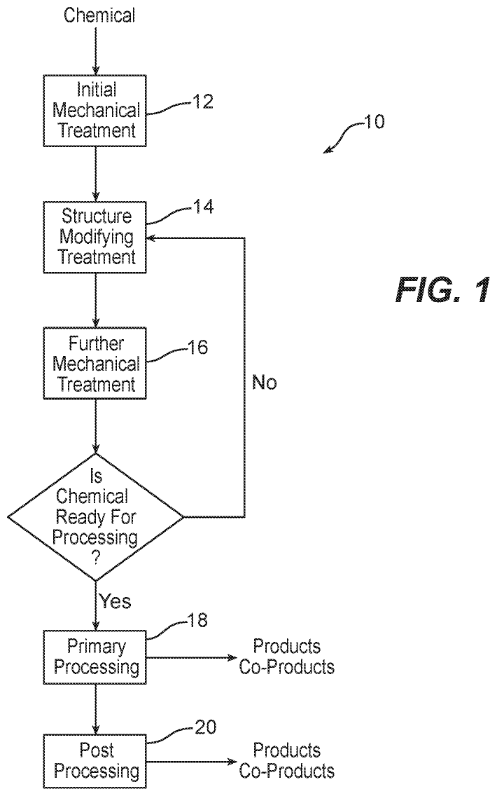

FIG. 1 shows a process 10 for converting a chemical into useful intermediates and products. Process 10 includes optionally initially mechanically treating the chemical (12), e.g., by grinding or other mechanical processing. The chemical is then treated with a physical treatment (14), such as mechanical treatment, chemical treatment, radiation, sonication, oxidation, pyrolysis or steam explosion, to modify its structure, for example by weakening or micro-fracturing bonds in the crystalline structure of the material. Next, the structurally modified chemical may in some cases be subjected to further mechanical treatment (16). This mechanical treatment can be the same as or different from the initial mechanical treatment.

The chemical can then be subjected to further structure-modifying treatment and mechanical treatment, if further structural change (e.g., increase in solubility) is desired prior to further processing.

Next, the treated chemical can be processed with a primary processing step 18, e.g., dissolved in a solvent and, in some cases, blended and/or reacted with other chemicals, to produce intermediates and products. In some cases, the output of the primary processing step is directly useful but, in other cases, requires further processing provided by a post-processing step (20). Post-processing can include, for example, purification, separation, addition of additives, drying, curing, and other processes.

In some cases, the systems described herein, or components thereof, may be portable, so that the system can be transported (e.g., by rail, truck, or marine vessel) from one location to another. The method steps described herein can be performed at one or more locations, and in some cases one or more of the steps can be performed in transit. Such mobile processing is described in U.S. Ser. No. 12/374,549 and International Application No. WO 2008/011598, the full disclosures of which are incorporated herein by reference.

Any or all of the method steps described herein can be performed at ambient temperature. If desired, cooling and/or heating may be employed during certain steps. For example, the chemical may be cooled during mechanical treatment to increase its brittleness. In some embodiments, cooling is employed before, during or after the initial mechanical treatment and/or the subsequent mechanical treatment. Cooling may be performed as described in 12/502,629, the full disclosure of which is incorporated herein by reference.

The individual steps of the methods described above, as well as the chemicals used, will now be described in further detail.

### Physical Treatment

Physical treatment processes can include one or more of any of those described herein, such as mechanical treatment, chemical treatment, irradiation, sonication, oxidation, pyrolysis or steam explosion. Treatment methods can be used in combinations of two, three, four, or even all of these technologies (in any order). When more than one treatment method is used, the methods can be applied at the same time or at different times. Other processes that change a molecular structure of a chemical to increase the solubility and/or rate of dissolution of the chemical may also be used, alone or in combination with the processes disclosed herein.

Many of the treatments described herein disrupt the crystalline structure of the treated chemical, which increases the solubility of the chemical with the increasing degree of disorder of the structure. Some of the treatments also increase the surface area and/or porosity of the chemical, which generally increases the rate of dissolution of the chemical as well as increasing its solubility.

### Mechanical Treatments

In some cases, methods can include mechanically treating the chemical. Mechanical treatments include, for example, cutting, milling, pressing, grinding, shearing and chopping. Milling may include, for example, ball milling, hammer milling, rotor/stator dry or wet milling, or other types of milling. Other mechanical treatments include, e.g., stone grinding, cracking, mechanical ripping or tearing, pin grinding or air attrition milling.

Mechanical treatment can be advantageous for “opening up,” “stressing,” breaking and shattering the chemical, making the chemical more susceptible to chain scission and/or reduction of crystallinity, and in some cases more susceptible to oxidation when irradiated.

In some cases, the mechanical treatment may include an initial preparation of the chemical, such as by cutting, grinding, shearing, pulverizing or chopping. Alternatively, or in addition, the chemical can first be physically treated by one or more of the other physical treatment methods, e.g., chemical treatment, radiation, sonication, oxidation, pyrolysis or steam explosion, and then mechanically treated. This sequence can be advantageous since chemicals treated by one or more of the other treatments, e.g., irradiation or pyrolysis, tend to be more brittle and, therefore, it may be easier to further change the molecular structure of the chemical by mechanical treatment.

Methods of mechanically treating the chemical include, for example, milling or grinding. Milling may be performed using, for example, a hammer mill, ball mill, colloid mill, conical or cone mill, disk mill, edge mill, Wiley mill or grist mill. Grinding may be performed using, for example, a stone grinder, pin grinder, coffee grinder, or burr grinder. Grinding may be provided, for example, by a reciprocating pin or other element, as is the case in a pin mill. Other mechanical treatment methods include mechanical ripping or tearing, other methods that apply pressure to the chemical, and air attrition milling. Suitable mechanical treatments further include any other technique that changes the molecular structure of the chemical.

Mechanical treatment systems can be configured to provide the treated chemical with specific morphology characteristics such as, for example, surface area, porosity, and bulk density. Increasing the surface area and porosity of the chemical will generally increase the solubility and rate of dissolution of the chemical.

In some embodiments, a BET surface area of the mechanically treated chemical is greater than 0.1 m²/g, e.g., greater than 0.25 m²/g, greater than 0.5 m²/g, greater than 1.0 m²/g, greater than 1.5 m²/g, greater than 1.75 m²/g, greater than 5.0 m²/g, greater than 10 m²/g, greater than 25 m²/g, greater than 35 m²/g, greater than 50 m²/g, greater than 60 m²/g, greater than 75 m²/g, greater than 100 m²/g, greater than 150 m²/g, greater than 200 m²/g, or even greater than 250 m²/g.

A porosity of the mechanically treated chemical can be, e.g., greater than 20 percent, greater than 25 percent, greater than 35 percent, greater than 50 percent, greater than 60 percent, greater than 70 percent, greater than 80 percent, greater than 85 percent, greater than 90 percent, greater than 92 percent, greater than 94 percent, greater than 95 percent, greater than 97.5 percent, greater than 99 percent, or even greater than 99.5 percent.

In some embodiments, after mechanical treatment the chemical has a bulk density of less than 0.25 g/cm³, e.g., 0.20 g/cm³, 0.15 g/cm³, 0.10 g/cm³, 0.05 g/cm³ or less, e.g., 0.025 g/cm³. Bulk density is determined using ASTM D1895B. Briefly, the method involves filling a measuring cylinder of known volume with a sample and obtaining a weight of the sample. The bulk density is calculated by dividing the weight of the sample in grams by the known volume of the cylinder in cubic centimeters.

In some situations, it can be desirable to prepare a low bulk density material, densify the material (e.g., to make it easier and less costly to transport to another site), and then revert the material to a lower bulk density state. Densified materials can be processed by any of the methods described herein, or any material processed by any of the methods described herein can be subsequently densified, e.g., as disclosed in U.S. Pat. No. 7,932,065 to Medoff, and International Application Pub. No. WO 2008/073186 to Medoff, which designated the United States and was published in English, the full disclosures of which are incorporated herein by reference.

### Radiation Treatment

One or more radiation processing sequences can be used to process the chemical, and to provide a structurally modified chemical, which has increased solubility and/or rate of dissolution relative to the chemical prior to irradiation. Irradiation can, for example, reduce the molecular weight and/or crystallinity of the chemical. Radiation can also sterilize the chemical, or any media needed to process the chemical.

In some embodiments, energy deposited in a material that releases an electron from its atomic orbital is used to irradiate the materials. The radiation may be provided by (1) heavy charged particles, such as alpha particles or protons, (2) electrons, produced, for example, in beta decay or electron beam accelerators, or (3) electromagnetic radiation, for example, gamma rays, x rays, or ultraviolet rays. In one approach, radiation produced by radioactive substances can be used to irradiate the chemical. In another approach, electromagnetic radiation (e.g., produced using electron beam emitters) can be used to irradiate the chemical. In some embodiments, any combination in any order or concurrently of (1) through (3) may be utilized. The doses applied depend on the desired effect and the particular chemical.

In some instances when chain scission is desirable and/or polymer chain functionalization is desirable, particles heavier than electrons, such as protons, helium nuclei, argon ions, silicon ions, neon ions, carbon ions, phoshorus ions, oxygen ions or nitrogen ions can be utilized. When ring-opening chain scission is desired, positively charged particles can be utilized for their Lewis acid properties for enhanced ring-opening chain scission. For example, when maximum oxidation is desired, oxygen ions can be utilized, and when maximum nitration is desired, nitrogen ions can be utilized. The use of heavy particles and positively charged particles is described in U.S. Pat. No. 7,931,784 to Medoff, the full disclosure of which is incorporated herein by reference.

In one method, a first chemical having a first number average molecular weight (M_{N1}) is irradiated, e.g., by treatment with ionizing radiation (e.g., in the form of gamma radiation, X-ray radiation, 100 nm to 280 nm ultraviolet (UV) light, a beam of electrons or other charged particles) to provide a second chemical having a second number average molecular weight (M_{N2}) lower than the first number average molecular weight. The second chemical (or the first and second chemical) can be used as a final product of further processed to produce an intermediate or product.

Since the second chemical has a reduced molecular weight relative to the first chemical, and in some instances, a reduced crystallinity as well, the second chemical exhibits greater solubility and/or a higher rate of dissolution relative to the first chemical. These properties can make the second chemical easier to process and in some cases more reactive, which can greatly improve the production rate and/or production level of a desired product.

In some embodiments, the second number average molecular weight (M_{N2}) is lower than the first number average molecular weight (M_{N1}) by more than about 10 percent, e.g., more than about 15, 20, 25, 30, 35, 40, 50 percent, 60 percent, or even more than about 75 percent.

In some instances, irradiating decreases the crystallinity of the chemical, e.g., by more than about 10 percent, e.g., more than about 15, 20, 25, 30, 35, 40, or even more than about 50 percent.

In some embodiments, the starting crystallinity index (prior to irradiation) is from about 40 to about 87.5 percent, e.g., from about 50 to about 75 percent or from about 60 to about 70 percent, and the crystallinity index after irradiation is from about 10 to about 50 percent, e.g., from about 15 to about 45 percent or from about 20 to about 40 percent. However, in some embodiments, e.g., after extensive irradiation, it is possible to have a crystallinity index of lower than 5 percent. In some embodiments, the material after irradiation is substantially amorphous.

In some embodiments, the starting number average molecular weight (prior to irradiation) is from about 200,000 to about 3,200,000, e.g., from about 250,000 to about 1,000,000 or from about 250,000 to about 700,000, and the number average molecular weight after irradiation is from about 50,000 to about 200,000, e.g., from about 60,000 to about 150,000 or from about 70,000 to about 125,000. However, in some embodiments, e.g., after extensive irradiation, it is possible to have a number average molecular weight of less than about 10,000 or even less than about 5,000.

In some embodiments, the second chemical can have a level of oxidation (O₂) that is higher than the level of oxidation (O₁) of the first chemical. A higher level of oxidation of the chemical can further increase its solubility and/or rate of dissolution. In some embodiments, to increase the level of the oxidation the irradiation is performed under an oxidizing environment, e.g., under a blanket of air or oxygen. In some cases, the second chemical can have more hydroxyl groups, aldehyde groups, ketone groups, ester groups or carboxylic acid groups, than the first chemical, which can increase hydrophilicity and thus solubility in water or aqueous media.

Ionizing Radiation

Each form of radiation ionizes the carbon-containing material via particular interactions, as determined by the energy of the radiation. Heavy charged particles primarily ionize matter via Coulomb scattering; furthermore, these interactions produce energetic electrons that may further ionize matter. Alpha particles are identical to the nucleus of a helium atom and are produced by the alpha decay of various radioactive nuclei, such as isotopes of bismuth, polonium, astatine, radon, francium, radium, several actinides, such as actinium, thorium, uranium, neptunium, curium, californium, americium, and plutonium.

When particles are utilized, they can be neutral (uncharged), positively charged or negatively charged. When charged, the charged particles can bear a single positive or negative charge, or multiple charges, e.g., one, two, three or even four or more charges. In instances in which chain scission is desired, positively charged particles may be desirable, in part due to their acidic nature. When particles are utilized, the particles can have the mass of a resting electron, or greater, e.g., 500, 1000, 1500, 2000, 10,000 or even 100,000 times the mass of a resting electron. For example, the particles can have a mass of from about 1 atomic unit to about 150 atomic units, e.g., from about 1 atomic unit to about 50 atomic units, or from about 1 to about 25, e.g., 1, 2, 3, 4, 5, 10, 12 or 15 amu. Accelerators used to accelerate the particles can be electrostatic DC, electrodynamic DC, RF linear, magnetic induction linear or continuous wave. For example, cyclotron type accelerators are available from IBA, Belgium, such as the Rhodotron® system, while DC type accelerators are available from RDI, now IBA Industrial, such as the Dynamitron®. Ions and ion accelerators are discussed in Introductory Nuclear Physics, Kenneth S. Krane, John Wiley & Sons, Inc. (1988), Krsto Prelec, FIZIKA B 6 (1997) 4, 177-206, Chu, William T., “Overview of Light-Ion Beam Therapy” Columbus-Ohio, ICRU-IAEA Meeting, 18-20 Mar. 2006, Iwata, Y. et al., “Alternating-Phase-Focused IH-DTL for Heavy-Ion Medical Accelerators” Proceedings of EPAC 2006, Edinburgh, Scotland and Leaner, C. M. et al., “Status of the Superconducting ECR Ion Source Venus” Proceedings of EPAC 2000, Vienna, Austria.

Gamma radiation has the advantage of a significant penetration depth into a variety of materials. Sources of gamma rays include radioactive nuclei, such as isotopes of cobalt, calcium, technicium, chromium, gallium, indium, iodine, iron, krypton, samarium, selenium, sodium, thalium, and xenon.

Sources of x rays include electron beam collision with metal targets, such as tungsten or molybdenum or alloys, or compact light sources, such as those produced commercially by Lyncean.

Sources for ultraviolet radiation include deuterium or cadmium lamps.

Sources for infrared radiation include sapphire, zinc, or selenide window ceramic lamps.

Sources for microwaves include klystrons, Slevin type RF sources, or atom beam sources that employ hydrogen, oxygen, or nitrogen gases.

In some embodiments, a beam of electrons is used as the radiation source. A beam of electrons has the advantages of high dose rates (e.g., 1, 5, or even 10 Mrad per second), high throughput, less containment, and less confinement equipment. Electrons can also be more efficient at causing chain scission. In addition, electrons having energies of 4-10 MeV can have a penetration depth of 5 to 30 mm or more, such as 40 mm.

Electron beams can be generated, e.g., by electrostatic generators, cascade generators, transformer generators, low energy accelerators with a scanning system, low energy accelerators with a linear cathode, linear accelerators, and pulsed accelerators. Electrons as an ionizing radiation source can be useful, e.g., for relatively thin sections of material, e.g., less than 0.5 inch, e.g., less than 0.4 inch, 0.3 inch, 0.2 inch, or less than 0.1 inch. In some embodiments, the energy of each electron of the electron beam is from about 0.3 MeV to about 2.0 MeV (million electron volts), e.g., from about 0.5 MeV to about 1.5 MeV, or from about 0.7 MeV to about 1.25 MeV.

Electron beam irradiation devices may be procured commercially from Ion Beam Applications, Louvain-la-Neuve, Belgium or the Titan Corporation, San Diego, Calif. Typical electron energies can be 1 MeV, 2 MeV, 4.5 MeV, 7.5 MeV, or 10 MeV. Typical electron beam irradiation device power can be 1 kW, 5 kW, 10 kW, 20 kW, 50 kW, 100 kW, 250 kW, or 500 kW. The level of depolymerization of the chemical depends on the electron energy used and the dose applied, while exposure time depends on the power and dose. Typical doses may take values of 1 kGy, 5 kGy, 10 kGy, 20 kGy, 50 kGy, 100 kGy, or 200 kGy.

Ion Particle Beams

Particles heavier than electrons can be used. For example, protons, helium nuclei, argon ions, silicon ions, neon ions carbon ions, phoshorus ions, oxygen ions or nitrogen ions can be utilized. In some embodiments, particles heavier than electrons can induce higher amounts of chain scission (relative to lighter particles). In some instances, positively charged particles can induce higher amounts of chain scission than negatively charged particles due to their acidity.

Heavier particle beams can be generated, e.g., using linear accelerators or cyclotrons. In some embodiments, the energy of each particle of the beam is from about 1.0 MeV/atomic unit to about 6,000 MeV/atomic unit, e.g., from about 3 MeV/atomic unit to about 4,800 MeV/atomic unit, or from about 10 MeV/atomic unit to about 1,000 MeV/atomic unit.

In certain embodiments, ion beams can include more than one type of ion. For example, ion beams can include mixtures of two or more (e.g., three, four or more) different types of ions. Exemplary mixtures can include carbon ions and protons, carbon ions and oxygen ions, nitrogen ions and protons, and iron ions and protons. More generally, mixtures of any of the ions discussed above (or any other ions) can be used to form irradiating ion beams. In particular, mixtures of relatively light and relatively heavier ions can be used in a single ion beam.

In some embodiments, ion beams for irradiating materials include positively charged ions. The positively charged ions can include, for example, positively charged hydrogen ions (e.g., protons), noble gas ions (e.g., helium, neon, argon), carbon ions, nitrogen ions, oxygen ions, silicon atoms, phosphorus ions, and metal ions such as sodium ions, calcium ions, and/or iron ions. Without wishing to be bound by any theory, it is believed that such positively-charged ions behave chemically as Lewis acid moieties when exposed to materials, initiating and sustaining cationic ring-opening chain scission reactions in an oxidative environment.

In certain embodiments, ion beams for irradiating materials include negatively-charged ions. Negatively charged ions can include, for example, negatively charged hydrogen ions (e.g., hydride ions), and negatively charged ions of various relatively electronegative nuclei (e.g., oxygen ions, nitrogen ions, carbon ions, silicon ions, and phosphorus ions). Without wishing to be bound by any theory, it is believed that such negatively-charged ions behave chemically as Lewis base moieties when exposed to materials, causing anionic ring-opening chain scission reactions in a reducing environment.

In some embodiments, beams for irradiating materials can include neutral atoms. For example, any one or more of hydrogen atoms, helium atoms, carbon atoms, nitrogen atoms, oxygen atoms, neon atoms, silicon atoms, phosphorus atoms, argon atoms, and iron atoms can be included in the beams. In general, mixtures of any two or more of the above types of atoms (e.g., three or more, four or more, or even more) can be present in the beams.

In certain embodiments, ion beams used to irradiate materials include singly-charged ions such as one or more of H⁺, H⁻, He⁺, Ne⁺, Ar⁺, C⁺, C⁻, O⁺, O⁻, N⁺ N⁻, Si⁺, S⁻, P⁺, P⁻, Na⁺, Ca⁺, and Fe⁺. In some embodiments, ion beams can include multiply-charged ions such as one or more of C²⁺, C³⁺, C⁴⁺, N³⁺, N⁵⁺, N³⁻, O²⁺, O²⁻, O₂²⁻, Si²⁺, Si⁴⁺, and Si⁴⁻. In general, the ion beams can also include more complex polynuclear ions that bear multiple positive or negative charges. In certain embodiments, by virtue of the structure of the polynuclear ion, the positive or negative charges can be effectively distributed over substantially the entire structure of the ions. In some embodiments, the positive or negative charges can be localized over portions of the structure of the ions.

Electromagnetic Radiation

In embodiments in which the irradiating is performed with electromagnetic radiation, the electromagnetic radiation can have, e.g., energy per photon (in electron volts) of greater than 10² eV, e.g., greater than 10³, 10⁴, 10⁵, 10⁶, or even greater than 10⁷ eV. In some embodiments, the electromagnetic radiation has energy per photon of between 10⁴ and 10⁷, e.g., between 10⁵ and 10⁶ eV. The electromagnetic radiation can have a frequency of, e.g., greater than 10¹⁶ hz, greater than 10¹⁷ hz, 10¹⁸, 10¹⁹, 10²⁰, or even greater than 10²¹ hz. In some embodiments, the electromagnetic radiation has a frequency of between 10¹⁸ and 10²² hz, e.g., between 10¹⁹ to 10²¹ hz.

Quenching and Controlled Functionalization of Chemicals

After treatment with ionizing radiation, the treated chemical may become ionized; that is, it may include radicals at levels that are detectable with an electron spin resonance spectrometer. If an ionized chemical remains in the atmosphere, it will be oxidized, such as to an extent that carboxylic acid groups are generated by reacting with the atmospheric oxygen. Such oxidation is desirable because it can aid in the further breakdown in molecular weight of the chemical, and the oxidation groups, e.g., carboxylic acid groups, can be helpful for solubility. However, since the radicals can “live” for some time after irradiation, e.g., longer than 1 day, 5 days, 30 days, 3 months, 6 months or even longer than 1 year, material properties can continue to change over time, which in some instances, can be undesirable.

After ionization, any material that has been ionized can be quenched to reduce the level of radicals in the ionized material, e.g., such that the radicals are no longer detectable with the electron spin resonance spectrometer. For example, the radicals can be quenched by the application of a sufficient pressure to the ionized material and/or by utilizing a fluid in contact with the ionized material, such as a gas or liquid, that reacts with (quenches) the radicals. Using a gas or liquid to at least aid in the quenching of the radicals can be used to functionalize the ionized material with a desired amount and kind of functional groups, such as carboxylic acid groups, enol groups, aldehyde groups, nitro groups, nitrile groups, amino groups, alkyl amino groups, alkyl groups, chloroalkyl groups or chlorofluoroalkyl groups.

Functionalization may change the polarity of the chemical, which will generally affect the solubility of the chemical, e.g., an increase in polarity will generally increase the solubility of the chemical in polar solvents. For example, different functional groups exhibit different degrees of hydrogen bonding and net dipole moment, and numbers of electronegative atoms. For example, aldehyde groups have a large dipole moment and are thus relatively polar, as are amines and alcohols, which have the ability to hydrogen bond. Carboxylic Acids are the most polar functional group because they can hydrogen bond extensively, have a dipole moment, and include two electronegative atoms.

In some embodiments, quenching includes an application of pressure to the ionized material, e.g., by directly mechanically compressing the material in one, two, or three dimensions, or applying pressure to a fluid in which the material is immersed, e.g., isostatic pressing. In such instances, the deformation of the material itself brings radicals, which are often trapped in crystalline domains, in close enough proximity so that the radicals can recombine, or react with another group. In some instances, the pressure is applied together with the application of heat, such as a sufficient quantity of heat to elevate the temperature of the material to above a melting point or softening point of the material or a component of the material. Heat can improve molecular mobility in the material, which can aid in the quenching of the radicals. When pressure is utilized to quench, the pressure can be greater than about 1000 psi, such as greater than about 1250 psi, 1450 psi, 3625 psi, 5075 psi, 7250 psi, 10000 psi or even greater than 15000 psi.

In some embodiments, quenching includes contacting the ionized material with a fluid, such as a liquid or gas, e.g., a gas capable of reacting with the radicals, such as acetylene or a mixture of acetylene in nitrogen, ethylene, chlorinated ethylenes or chlorofluoroethylenes, propylene or mixtures of these gases. In other particular embodiments, quenching includes contacting the ionized material with a liquid, e.g., a liquid capable of penetrating into the material and reacting with the radicals, such as a diene, such as 1,5-cyclooctadiene. In some specific embodiments, quenching includes contacting the ionized material with an antioxidant, such as Vitamin E. If desired, the chemical can include an antioxidant dispersed therein.

Functionalization can be enhanced by utilizing heavy charged ions, such as any of the heavier ions described herein. For example, if it is desired to enhance oxidation, charged oxygen ions can be utilized for the irradiation. If nitrogen functional groups are desired, nitrogen ions or anions that include nitrogen can be utilized. Likewise, if sulfur or phosphorus groups are desired, sulfur or phosphorus ions can be used in the irradiation.

Doses

In some instances, the irradiation is performed at a dosage rate of greater than about 0.25 Mrad per second, e.g., greater than about 0.5, 0.75, 1.0, 1.5, 2.0, or even greater than about 2.5 Mrad per second. In some embodiments, the irradiating is performed at a dose rate of between 5.0 and 1500.0 kilorads/hour, e.g., between 10.0 and 750.0 kilorads/hour or between 50.0 and 350.0 kilorads/hour.

In some embodiments, the irradiating (with any radiation source or a combination of sources) is performed until the material receives a dose of at least 0.1 Mrad, at least 0.25 Mrad, e.g., at least 1.0 Mrad, at least 2.5 Mrad, at least 5.0 Mrad, at least 10.0 Mrad, at least 60 Mrad or at least 100 Mrad. In some embodiments, the irradiating is performed until the material receives a dose of from about 0.1 Mrad to about 500 Mrad, from about 0.5 Mrad to about 200 Mrad, from about 1 Mrad to about 100 Mrad, or from about 5 Mrad to about 60 Mrad. In some embodiments, a relatively low dose of radiation is applied, e.g., less than 60 Mrad.

### Sonication

Sonication can reduce the molecular weight and/or crystallinity of a chemical and thereby increase the solubility and/or rate of dissolution of the chemical. Sonication can also be used to sterilize the chemical and/or any media used to process the chemical.

In one method, a first chemical having a first number average molecular weight (M_{N1}) is dispersed in a medium, such as water, and sonicated and/or otherwise cavitated, to provide a second chemical having a second number average molecular weight (M_{N2}) lower than the first number average molecular weight.

In some embodiments, the second number average molecular weight (M_{N2}) is lower than the first number average molecular weight (M_{N1}) by more than about 10 percent, e.g., more than about 15, 20, 25, 30, 35, 40, 50 percent, 60 percent, or even more than about 75 percent.

In some instances, the second chemical has a crystallinity (C₂) that is lower than the crystallinity (C₁) of the first chemical. For example, (C₂) can be lower than (C₁) by more than about 10 percent, e.g., more than about 15, 20, 25, 30, 35, 40, or even more than about 50 percent.

In some embodiments, the starting crystallinity index (prior to sonication) is from about 40 to about 87.5 percent, e.g., from about 50 to about 75 percent or from about 60 to about 70 percent, and the crystallinity index after sonication is from about 10 to about 50 percent, e.g., from about 15 to about 45 percent or from about 20 to about 40 percent. However, in certain embodiments, e.g., after extensive sonication, it is possible to have a crystallinity index of lower than 5 percent. In some embodiments, the material after sonication is substantially amorphous.

In some embodiments, the starting number average molecular weight (prior to sonication) is from about 200,000 to about 3,200,000, e.g., from about 250,000 to about 1,000,000 or from about 250,000 to about 700,000, and the number average molecular weight after sonication is from about 50,000 to about 200,000, e.g., from about 60,000 to about 150,000 or from about 70,000 to about 125,000. However, in some embodiments, e.g., after extensive sonication, it is possible to have a number average molecular weight of less than about 10,000 or even less than about 5,000.

In some embodiments, the second chemical can have a level of oxidation (O₂) that is higher than the level of oxidation (O₁) of the first chemical. In some embodiments, to increase the level of oxidation of the second chemical relative to the first chemical, sonication is performed in an oxidizing medium. In some cases, the second chemical can have more hydroxyl groups, aldehyde groups, ketone groups, ester groups or carboxylic acid groups, which can increase its hydrophilicity.

In some embodiments, the sonication medium is an aqueous medium. If desired, the medium can include an oxidant, such as a peroxide (e.g., hydrogen peroxide), a dispersing agent and/or a buffer. Examples of dispersing agents include ionic dispersing agents, e.g., sodium lauryl sulfate, and non-ionic dispersing agents, e.g., poly(ethylene glycol).

In other embodiments, the sonication medium is non-aqueous. For example, the sonication can be performed in a hydrocarbon, e.g., toluene or heptane, an ether, e.g., diethyl ether or tetrahydrofuran, or even in a liquefied gas such as argon, xenon, or nitrogen.

It is generally preferred that the chemical be insoluble in the sonication medium, at least prior to sonication.

### Pyrolysis

One or more pyrolysis processing sequences can be used to increase the solubility and/or rate of dissolution of a chemical. Pyrolysis can also be used to sterilize the chemical and/or any media used to process the chemical.

In one example, a first chemical having a first number average molecular weight (M_{N1}) is pyrolyzed, e.g., by heating the first chemical in a tube furnace (in the presence or absence of oxygen), to provide a second chemical having a second number average molecular weight (M_{N2}) lower than the first number average molecular weight.

In some embodiments, the second number average molecular weight (M_{N2}) is lower than the first number average molecular weight (M_{N1}) by more than about 10 percent, e.g., more than about 15, 20, 25, 30, 35, 40, 50 percent, 60 percent, or even more than about 75 percent.

In some instances, the second chemical has a crystallinity (C₂) that is lower than the crystallinity (C₁) of the first chemical. For example, (C₂) can be lower than (C₁) by more than about 10 percent, e.g., more than about 15, 20, 25, 30, 35, 40, or even more than about 50 percent.

In some embodiments, the starting crystallinity (prior to pyrolysis) is from about 40 to about 87.5 percent, e.g., from about 50 to about 75 percent or from about 60 to about 70 percent, and the crystallinity index after pyrolysis is from about 10 to about 50 percent, e.g., from about 15 to about 45 percent or from about 20 to about 40 percent. However, in certain embodiments, e.g., after extensive pyrolysis, it is possible to have a crystallinity index of lower than 5 percent.

In some embodiments, the material after pyrolysis is substantially amorphous.

In some embodiments, the starting number average molecular weight (prior to pyrolysis) is from about 200,000 to about 3,200,000, e.g., from about 250,000 to about 1,000,000 or from about 250,000 to about 700,000, and the number average molecular weight after pyrolysis is from about 50,000 to about 200,000, e.g., from about 60,000 to about 150,000 or from about 70,000 to about 125,000. However, in some embodiments, e.g., after extensive pyrolysis, it is possible to have a number average molecular weight of less than about 10,000 or even less than about 5,000.

In some embodiments, the second chemical can have a level of oxidation (O₂) that is higher than the level of oxidation (O₁) of the first chemical. In some embodiments, to increase the level of the oxidation the pyrolysis is performed in an oxidizing environment. In some cases, the second material can have more hydroxyl groups, aldehyde groups, ketone groups, ester groups or carboxylic acid groups, than the first material, thereby increasing the hydrophilicity of the material.

In some embodiments, pyrolysis is continuous. In other embodiments, the chemical is pyrolyzed for a predetermined time, and then allowed to cool for a second predetermined time before pyrolyzing again.

### Oxidation

One or more oxidative processing sequences can be used to increase the solubility and/or dissolution rate of the chemical.

In one method, a first chemical having a first number average molecular weight (M_{N1}) and having a first oxygen content (O₁) is oxidized, e.g., by heating the first chemical in a stream of air or oxygen-enriched air, to provide a second chemical having a second number average molecular weight (M_{N2}) and having a second oxygen content (O₂) higher than the first oxygen content (O₁).

The second number average molecular weight of the second chemical is generally lower than the first number average molecular weight of the first chemical. For example, the molecular weight may be reduced to the same extent as discussed above with respect to the other physical treatments. The crystallinity of the second material may also be reduced to the same extent as discussed above with respect to the other physical treatments.

In some embodiments, the second oxygen content is at least about five percent higher than the first oxygen content, e.g., 7.5 percent higher, 10.0 percent higher, 12.5 percent higher, 15.0 percent higher or 17.5 percent higher. In some preferred embodiments, the second oxygen content is at least about 20.0 percent higher than the first oxygen content. Oxygen content is measured by elemental analysis by pyrolyzing a sample in a furnace operating at 1300° C. or higher. A suitable elemental analyzer is the LECO CHNS-932 analyzer with a VTF-900 high temperature pyrolysis furnace.

Generally, oxidation of a material occurs in an oxidizing environment. For example, the oxidation can be effected or aided by pyrolysis in an oxidizing environment, such as in air or argon enriched in air. To aid in the oxidation, various chemical agents, such as oxidants, acids or bases can be added to the chemical prior to or during oxidation. For example, a peroxide (e.g., benzoyl peroxide) can be added prior to oxidation.

Some oxidative methods employ Fenton-type chemistry. Such methods are disclosed, for example, in U.S. Ser. No. 12/639,289, by Medoff and Masterman, and published as U.S. Pat. App. Pub. 2010/0159569, the complete disclosure of which is incorporated herein by reference.

Exemplary oxidants include peroxides, such as hydrogen peroxide and benzoyl peroxide, persulfates, such as ammonium persulfate, activated forms of oxygen, such as ozone, permanganates, such as potassium permanganate, perchlorates, such as sodium perchlorate, and hypochlorites, such as sodium hypochlorite (household bleach).

In some situations, pH is maintained at or below about 5.5 during contact, such as between 1 and 5, between 2 and 5, between 2.5 and 5 or between about 3 and 5. Oxidation conditions can also include a contact period of between 2 and 12 hours, e.g., between 4 and 10 hours or between 5 and 8 hours. In some instances, temperature is maintained at or below 300° C., e.g., at or below 250, 200, 150, 100 or 50° C. In some instances, the temperature remains substantially ambient, e.g., at or about 20-25° C.

In some embodiments, the one or more oxidants are applied as a gas, such as by generating ozone in-situ by irradiating the material through air with a beam of particles, such as electrons.

In some embodiments, the mixture further includes one or more hydroquinones, such as 2,5-dimethoxyhydroquinone (DMHQ) and/or one or more benzoquinones, such as 2,5-dimethoxy-1,4-benzoquinone (DMBQ), which can aid in electron transfer reactions.

In some embodiments, the one or more oxidants are electrochemically-generated in-situ. For example, hydrogen peroxide and/or ozone can be electro-chemically produced within a contact or reaction vessel.

### Other Processes to Solubilize or Functionalize

Any of the processes of this paragraph can be used alone without any of the processes described herein, or in combination with any of the processes described herein (in any order): steam explosion, chemical treatment (e.g., acid treatment (including concentrated and dilute acid treatment with mineral acids, such as sulfuric acid, hydrochloric acid and organic acids, such as trifluoroacetic acid) and/or base treatment (e.g., treatment with lime or sodium hydroxide)), UV treatment, screw extrusion treatment (see, e.g., International Application Publication No. WO 2010/056940 by Medoff, solvent treatment (e.g., treatment with ionic liquids) and freeze milling (see, e.g., U.S. Pat. No. 7,900,857 to Medoff).

### Intermediates and Products

In some cases, the treated chemical is itself a finished product, e.g., a salt or polymer having improved solubility and/or rate of dissolution. In other cases, using primary processes and/or post-processing, the treated chemical can be converted to one or more products, such as energy, fuels, foods and materials. A wide variety of products can be made and/or used more efficiently if the solubility of a component chemical is increased. Just a few examples include binders and/or pigments used in paints, inks and coatings, ingredients used in food products, and ingredients used in pharmaceuticals.

Specific examples of products that may be manufactured by a reaction or process utilizing the physically treated chemical include, but are not limited to, hydrogen, alcohols (e.g., monohydric alcohols or dihydric alcohols, such as ethanol, n-propanol or n-butanol), hydrated or hydrous alcohols, e.g., containing greater than 10%, 20%, 30% or even greater than 40% water, sugars, biodiesel, organic acids (e.g., acetic acid and/or lactic acid), hydrocarbons, co-products (e.g., proteins, such as cellulolytic proteins (enzymes) or single cell proteins), and mixtures of any of these in any combination or relative concentration, and optionally in combination with any additives, e.g., fuel additives. Other examples include carboxylic acids, such as acetic acid or butyric acid, salts of a carboxylic acid, a mixture of carboxylic acids and salts of carboxylic acids and esters of carboxylic acids (e.g., methyl, ethyl and n-propyl esters), ketones, aldehydes, alpha, beta unsaturated acids, such as acrylic acid and olefins, such as ethylene. Other alcohols and alcohol derivatives include propanol, propylene glycol, 1,4-butanediol, 1,3-propanediol, methyl or ethyl esters of any of these alcohols. Other products include methyl acrylate, methylmethacrylate, lactic acid, propionic acid, butyric acid, succinic acid, 3-hydroxypropionic acid, a salt of any of the acids and a mixture of any of the acids and respective salts.

Other intermediates and products, including food and pharmaceutical products, are described in U.S. Pat. App. Pub. 2010/0124583 by Medoff, the full disclosure of which is hereby incorporated by reference herein.

### Chemicals

The chemical to be treated can be, for example, one or more of any of the following: salts, polymers, monomers, pharmaceuticals, nutriceuticals, vitamins, minerals, neutral molecules, or mixtures of any of these.

Salts may include, for example, any of the following cations: ammonium, calcium, iron, magnesium, potassium, pyridinium, quaternary ammonium, and sodium, and any of the following anions: acetate, carbonate, chloride, citrate, cyanide, hydroxide, nitrate, nitrite, oxide, phosphate, and sulfate. The salt may be, for example, an electrolyte.

Polymers include natural and synthetic polymers. The polymer may be a polar macromolecule, e.g., poly(acrylic acid), poly(acrylamide) or polyvinyl alcohol, which is soluble in water prior to physical treatment, or a nonpolar polymer or polymer showing a low polarity, e.g., polystyrene, poly(methyl methacrylate), poly(vinyl chloride), or poly(isobutylene), which is soluble in nonpolar solvents prior to physical treatment. Examples of polymers include latex, acrylics, polyurethanes, polyesters, polyethylenes, polystyrenes, polybutadienes, and polyamides.

### Other Embodiments

A number of embodiments of the invention have been described. Nevertheless, it will be understood that various modifications may be made without departing from the spirit and scope of the invention.

For example, while it is possible to perform all the processes described herein all at one physical location, in some embodiments, the processes are completed at multiple sites, and/or may be performed during transport.

Accordingly, other embodiments are within the scope of the following claims.

What is claimed is:

1. A method of increasing the solubility of a chemical comprising treating the chemical with a physical treatment selected from the group consisting of mechanical treatment, chemical treatment, radiation, sonication, oxidation, pyrolysis and steam explosion to increase the solubility of the chemical relative to the solubility of the chemical prior to physical treatment.

2. The method of claim 1 wherein the chemical is selected from the group consisting of salts, polymers and monomers.

3. The method of claim 1 wherein the physical treatment comprises irradiation.

4. The method of claim 1 wherein the physical treatment changes the functionality of the chemical.

5. The method of claim 3 wherein irradiating comprises exposing the chemical to an electron beam.

6. The method of claim 3 wherein irradiating comprises applying to the chemical a total dose of radiation of at least 5 Mrads.

7. The method of claim 1 wherein the physically treated chemical has a crystallinity that is at least 10 percent lower than the crystallinity of the chemical prior to physical treatment.

8. The method of claim 1 wherein the chemical had a crystallinity index prior to physical treatment of from about 40 to about 87.5 percent, and the physically treated chemical has a crystallinity index of from about 10 to about 50 percent.

9. A product comprising a chemical that has been treated with a physical treatment selected from the group consisting of mechanical treatment, chemical treatment, radiation, sonication, oxidation, pyrolysis and steam explosion, the product having a solubility that is higher than the solubility of the chemical prior to physical treatment.

10. The product of claim 9 wherein the chemical is selected from the group consisting of salts, polymers and monomers.

11. The product of claim 9 wherein the chemical has been irradiated.

12. The product of claim 9 wherein the product has a functionality that is different from that of the chemical prior to physical treatment.

13. The product of claim 11 wherein the chemical has been irradiated by exposing the chemical to an electron beam.

14. The product of claim 11 wherein the chemical has been irradiated with a total dose of radiation of at least 5 Mrads.

15. The product of claim 9 wherein the physically treated chemical has a crystallinity that is at least 10 percent lower than the crystallinity of the chemical prior to physical treatment.

16. The product of claim 9 wherein the chemical had a crystallinity index prior to physical treatment of from about 40 to about 87.5 percent, and the physically treated chemical has a crystallinity index of from about 10 to about 50 percent.
